(19) United States
(12) Patent Application Publication
(10) Pub. No.: US 2007/0034811 A1
(43) Pub. Date: Feb. 15, 2007

(54) Energy economizing combination

(76) Inventors: Kuo An Wu, Dali City (TW); Chuan Che Wu, Dali City (TW); Jo Ting Chuang, Dali City (TW)

Correspondence Address: CHARLES E. BAXLEY, ESQ., 90 JOHN STREET, THIRD FLOOR, NEW YORK, NY, 10038, US

(21) Appl. No.: 11/200,785

(22) Filed: Aug. 9, 2005

(51) Int. Cl. G01N 21/01; G01N 21/51

(52) U.S. Cl. 250/429

(57) ABSTRACT

An energy economizing combination includes a switch device coupled to an energy output unit, an energy discharging device coupled to the switch device for energy dissipating purposes, and one or more energy units coupled to the switch device, for selectively receiving energy from the energy output unit. The energy unit includes a switch member coupled to the switch device, and a load facility coupled to the switch member, for being controlled by the switch member. The energy unit includes two pipings coupled between the switch member and the load facility. A heat reservoir and a cold reservoir may further be coupled to the switch device, for receiving and storing cold energy.

### BACKGROUND OF THE INVENTION

1. Field of the Invention

The present invention relates to an energy economizing combination, and more particularly to an energy economizing combination for coupling various heat and cold facilities together, and for economizing heat and cold energies.

2. Description of the Prior Art

Typical load facilities, such as water heaters, heat exchanging devices, water drinking devices, warmers, refrigerators, air conditioners, etc. each may comprise an electric heater or a compressor that is required to be energized with electric energy, for heat exchanging purposes.

For example, the typical water heaters may comprise an electric heater which is also required to be energized with electric energy; and the typical refrigerators and air conditioners each may comprise a compressor which is also required to be energized with electric energy.

In addition, each of the typical load facilities may further require one or more fan devices for heat dissipating purposes, and/or for heat exchanging purposes, which are also required to be energized with electric energy.

However, the typical load facilities may not be coupled together, and thus may not have some of the devices or mechanisms to be used or shared with each other, and also may not share or receive the heat or cold energy from each other.

The present invention has arisen to mitigate and/or obviate the afore-described disadvantages of the conventional energy economizing combinations.

### SUMMARY OF THE INVENTION

The primary objective of the present invention is to provide an energy economizing combination including a number of heat and cold facilities which may be coupled together, for using or sharing some of the devices or mechanisms thereof, and thus for economizing heat and cold energies.

In accordance with one aspect of the invention, there is provided an energy economizing combination comprising an energy output unit, a switch device coupled to the energy output unit, an energy discharging device coupled to the switch device for energy dissipating purposes, and at least one energy unit coupled to the switch device, for selectively receiving energy from the energy output unit.

The energy unit includes a switch member coupled to the switch device, and a load facility coupled to the switch member, for being controlled by the switch member. The energy unit includes two pipings coupled between the switch member and the load facility, for allowing fluid or air to flow between the switch member and the load facility.

The energy unit includes an expansion valve coupled to one of the pipings. The energy unit includes an inlet tubing and an outlet tubing and a returning tubing coupled to the switch member.

A heat reservoir and/or a cold reservoir may further be provided and coupled to the switch device, for receiving and storing cold energy. An expansion valve may further be provided and coupled to the cold reservoir, for controlling a flowing of a fluid between the switch device and the cold reservoir.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a block diagram an energy economizing combination in accordance with the present invention;

FIG. 2 is an enlarged partial block diagram of the energy economizing combination; and

FIG. 3 is a block diagram similar to FIG. 1, illustrating one arrangement of the energy economizing combination.

### DETAILED DESCRIPTION OF THE PREFERRED EMBODIMENT

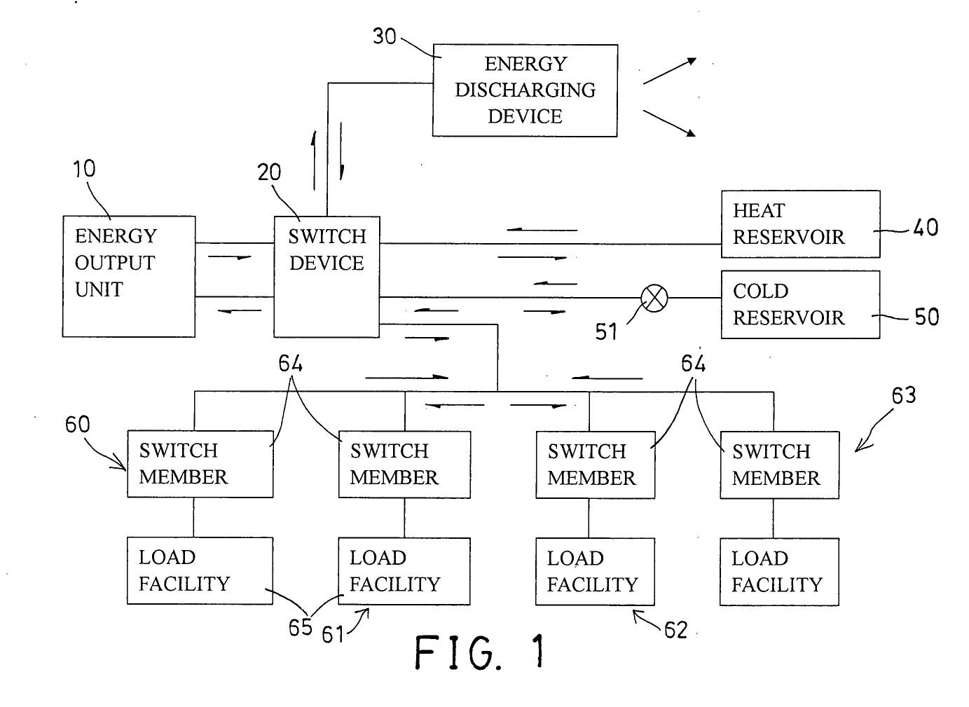

Referring to the drawings, and initially to FIG. 1, an energy economizing combination in accordance with the present invention comprises an energy output unit 10, such as a solar heater, a solar energy facility, or a compressor of a load facility such as air conditioner, for example.

A switch device 20 is coupled to the energy output unit 10, and an energy discharging device 30 is coupled to the switch device 20 for energy dissipating purposes. For example, the energy discharging device 30 may include one or more fan devices for heat dissipating purposes, and/or for heat exchanging purposes.

A heat reservoir 40 and a cold reservoir 50 may be coupled to the switch device 20, for receiving and supply heat and cold energy from such as the energy output unit 10 respectively. For example, the excessive heat or cold energy may be supplied into the heat reservoir 40 or the cold reservoir 50, when the energy economizing combination has the excessive heat or cold energy that may not be used or consumed. An expansion valve 51 may further be provided and coupled to the cold reservoir 50, for controlling the flowing of the fluid or liquid or the air between the switch device 20 and the cold reservoir 50.

The energy economizing combination may further include one or more energy units 60, 61, 62, 63 coupled in parallel to each other, and coupled to the switch device 20, for selectively receiving and supply heat and cold energy from such as the energy output unit 10 respectively. The energy units 60, 61, 62, 63 each also includes a switch member 64 coupled to the switch device 20, for controlling the energy units 60, 61, 62, 63 respectively.

The energy units 60, 61, 62, 63 each further includes a load facility 65 coupled to the switch member 64 respectively, for being controlled by the switch member 64 respectively. The load facilities 65 of the energy units 60, 61, 62, 63 may also be the water heaters, the heat exchanging devices, the water drinking devices, the warmers, the refrigerators, the air conditioners, etc.

When the energy units 60, 61, 62, 63 are not operated or energized, the heat reservoir 40 or the cold reservoir 50 may also be operated or worked to receive and/or to release heat or cold energy. For example, the heat reservoir 40 or the cold reservoir 50 may be operated or worked or switched on to receive and/or to release heat or cold energy when the temperature of the energy economizing combination has not reached the predetermined temperature; and may be stopped or switched off when the temperature of the energy economizing combination has reached the predetermined temperature.

In operation, when both the heat reservoir 40 or the cold reservoir 50 are stopped or switched off, the energy economizing combination will also be stopped or switched off. When the heat reservoir 40 is operated or worked or switched on and when the cold reservoir 50 is stopped or switched off, the energy discharging device 30 will discharge excessive cold energy.

On the contrary, when the heat reservoir 40 is stopped or switched off and when the cold reservoir 50 is operated or worked or switched on, the energy discharging device 30 will discharge excessive heat energy. When both the heat reservoir 40 or the cold reservoir 50 are operated or worked or switched on, the energy discharging device 30 will be stopped or switched off.

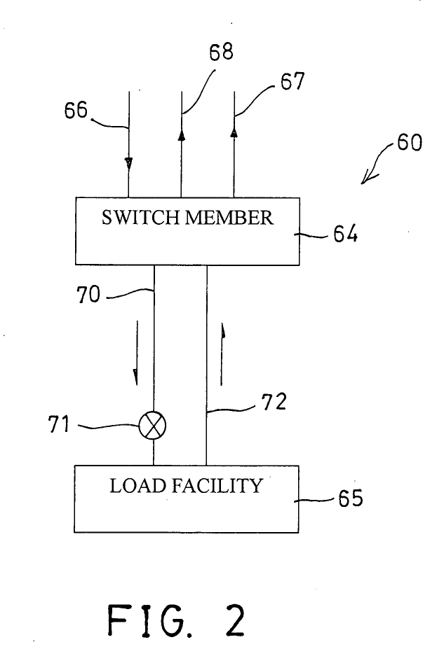

Referring next to FIG. 2, the energy units 60, 61, 62, 63 each may include an inlet tubing 66 coupled to the switch member 64, for receiving pressurized fluid or liquid, an outlet tubing 67 for outputting low pressure air or the like, and a returning tubing 68 for returning warm air, for example.

The energy units 60, 61, 62, 63 each further includes two pipings 70, 72 coupled between the switch member 64 and the load facility 65, for allowing fluid or air to flow to and from or between the switch member 64 and the load facility 65, and an expansion valve 71 coupled to one of the pipings 70, for controlling the flowing of the fluid or liquid or the air between the switch member 64 and the load facility 65.

In operation, when the energy unit 60 is a warmer device, for example, the warm air from the energy output unit 10 may be supplied to the switch member 64 via the inlet tubing 66 of the energy unit 60, and then flowing into the load facility 65 via the piping 70 and the expansion valve 71, in which the expansion valve 71 is opened and not operated, in order to output or to provide warm air via the load facility 65. The excessive energy or warm air may be recycled or returned via the other piping 72 and the switch member 64 and the returning tubing 68.

Cold air from the energy output unit 10 may be supplied to the switch member 64 via the inlet tubing 66 of the other energy unit 61 (for example), and then flowing into the load facility 65 via the piping 70 and the expansion valve 71, in order to output or to provide cold air via the load facility 65. The excessive energy or cold air may be recycled or returned via the other piping 72 and the switch member 64 and the outlet tubing 67.

Accordingly, the energy output from the energy output unit 10 may supply the warm air or heat energy to the load facility 65 of the energy unit 60 and/or 62 and/or 63, and may simultaneously and separately supply the cold air or cold energy to the load facility 65 of the other energy unit 61 and/or 62 and/or 63, to allow the heat facilities and the cold facilities to be coupled together. The excessive heat or cold energy from the energy output unit 10 and/or the energy units 60-63 may be discharged via the single energy discharging device 30, such that only one single energy discharging device 30 is required for all of the energy output unit 10 and the energy units 60-63.

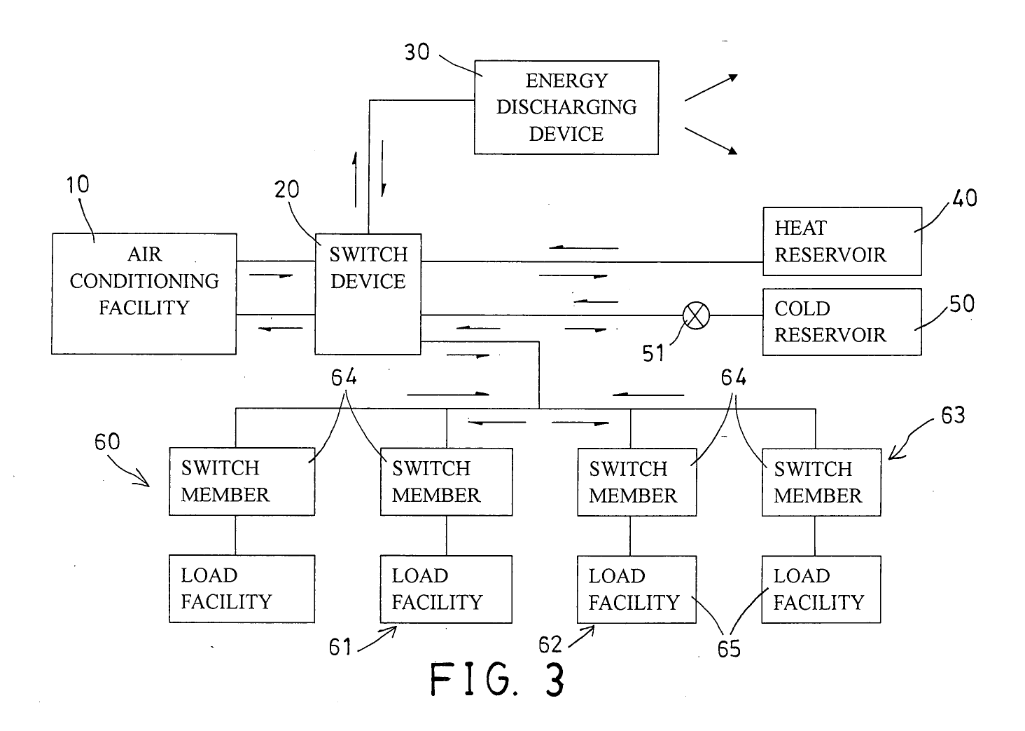

As shown in FIG. 3, when the energy output unit 10 is an air conditioning facility, for example, a compressor of the air conditioning facility may generate and supply excessive energy to the energy discharging device 30 and/or the heat reservoir 40 and/or the cold reservoir 50, and/or the energy units 60-63, for allowing the excessive energy, that will normally be discharged or wasted, to be used by the other facilities. The energy discharging device 30 may be the fan device 30 of the air conditioning facility, without additional energy discharging device 30.

Accordingly, the energy economizing combination in accordance with the present invention includes a number of heat and cold facilities which may be coupled together, for using or sharing some of the devices or mechanisms thereof, and thus for economizing heat and cold energies.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An energy economizing combination comprising:
an energy output unit,
a switch device coupled to said energy output unit,
an energy discharging device coupled to said switch device for energy dissipating purposes, and
at least one energy unit coupled to said switch device, for selectively receiving energy from said energy output unit.

2. The energy economizing combination as claimed in claim 1, wherein said at least one energy unit includes a switch member coupled to said switch device, and a load facility coupled to said switch member, for being controlled by said switch member.

3. The energy economizing combination as claimed in claim 2, wherein said at least one energy unit includes two pipings coupled between said switch member and said load facility, for allowing fluid or air to flow between said switch member and said load facility.

4. The energy economizing combination as claimed in claim 3, wherein said at least one energy unit includes an expansion valve coupled to one of said pipings.

5. The energy economizing combination as claimed in claim 2, wherein said at least one energy unit includes an inlet tubing and an outlet tubing and a returning tubing coupled to said switch member.

6. The energy economizing combination as claimed in claim 1 further comprising a heat reservoir coupled to said switch device, for receiving and storing heat energy.

7. The energy economizing combination as claimed in claim 1 further comprising a cold reservoir coupled to said switch device, for receiving and storing cold energy.

8. The energy economizing combination as claimed in claim 7 further comprising an expansion valve coupled to said cold reservoir, for controlling a flowing of a fluid between said switch device and said cold reservoir.
